(19) United States
(12) Patent Application Publication
(10) Pub. No.: US 2006/0168896 A1
(43) Pub. Date: Aug. 3, 2006

(54) Cursor assembly for a window regulator, in particular for vehicles

(75) Inventor: Jean-Michel Lecaille, Ouzouer sur Loire (FR)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Light Vehicle Systems-France

(21) Appl. No.: 11/330,273

(22) Filed: Jan. 11, 2006

(30) Foreign Application Priority Data
Jan. 20, 2005 (DE) 10 2005 002 759.8

(51) Int. Cl. B60J 5/04

(52) U.S. Cl. 49/502

(57) ABSTRACT

A cursor assembly for a window regulator, in particular for vehicles, includes a cursor displaceable along a guide, and a fastening clip attached to the cursor to be displaceable with respect to the cursor over a predefined path. The cursor has a fastening configuration that is adapted to be fastened to a window pane.

### RELATED APPLICATIONS

The application claims priority to German Application No. 10 2005 002 759.8 which was filed on Jan. 20, 2005.

### BACKGROUND OF THE INVENTION

The invention relates to a cursor assembly for a window regulator, in particular for vehicles.

Window regulators allow displacement of a window pane, for example the window pane in a vehicle door, between a closed position and an open position. Typically, a window regulator comprises at least one guide that is usually formed as a rail and is mounted in a generally vertical direction. A cursor is provided that is arranged at the guide to be displaceable thereon. Attached to the cursor is the window pane so that driving the cursor along the guide results in displacement of the window pane. To drive the cursor, a driving mechanism such as driving cables and an electric motor can be used.

As the window pane is not only attached to the cursor but also guided in a frame, proper alignment of all components is of significant importance for proper operation of the window regulator. However, even though tolerances of the various components of the window regulator system are kept as small as possible, a certain degree of compliance or elasticity, in particular in the region of the cursor, is required. Of particular importance is the degree of compliance for tolerances in the longitudinal direction of the vehicle (typically called the x-axis). The issue of tolerances is even more important for window regulator systems that use two parallel guides. To avoid an overdesigned system, only one of the cursors must be used to define the position of the window pane on the X-axis while the other cursor must allow for a compensation of tolerances. In the prior art, attempts were made to provide for compliance of the cursor by using components made from a plastic material. The disadvantage of such a design is that the system offers limited theft protection. The limited theft protection is in particular due to the requirement of forming the cursor with a limited wall thickness to allow the required compliance and deformability. If excessive forces are applied onto the window pane, the window pane may become separated from the cursor or the cursor might break, so that the window pane can be displaced downwardly, thereby allowing access to the interior of the vehicle.

The object of the invention is to provide a cursor assembly that allows for a compensation of tolerances while achieving superior theft protection.

### SUMMARY OF THE INVENTION

The subject invention solves this problem by providing a cursor assembly for a window regulator, in particular for vehicles, which includes a cursor that is displaceable along a guide, and a fastening clip attached to the cursor that is displaceable with respect to the cursor over a predefined path. The cursor also has a fastening configuration that allows the cursor to be fastened to a window pane. The invention is based on a concept of using two separate components that are displaceable with respect to each other, i.e., the cursor and the fastening clip. Using two separate components that are displaceable with respect to each other allows each of the components to be formed with a rigidity that is sufficient in view of theft protection.

According to a preferred embodiment of the invention, an oblong hole is used to attach the fastening clip to the cursor. The oblong hole cooperates with a projection for example, which engages into the oblong hole. This allows a limited path to be defined for a displacement of the fastening clip with respect to the cursor. Further, the direction of relative displacement is predefined, namely by choosing the orientation of the longer axis of the oblong hole. The oblong hole can be formed directly in a fastening tab or in a separate part.

According to the preferred embodiment, it is further provided that a screw is used to attach the fastening clip to the cursor, and additionally is used to attach the fastening configuration to the window pane. The screw is made from metal and provides a particularly strong connection between the window pane and the cursor, thereby increasing theft protection.

These and other features of the present invention can be best understood from the following specification and drawings, the following of which is a brief description.

### BRIEF DESCRIPTION OF THE DRAWINGS

FIG. 1 is a perspective view of a cursor assembly comprising a fastening clip and a cursor attached to a guide.

FIG. 2 is a perspective view of the cursor attached to the guide, with the fastening clip being removed.

FIG. 3 is a perspective view of the cursor assembly with the fastening clip provisionally mounted on the cursor.

FIG. 4 shows the fastening clip provisionally arranged at the cursor in one extreme position.

FIG. 5 shows the fastening clip provisionally arranged at the cursor in another extreme position.

FIG. 6 shows in a perspective view the cursor, the fastening clip and a screw prior to mounting.

FIG. 7 shows the fastening clip provisionally attached to the cursor.

FIG. 8 shows the fastening clip mounted to the cursor with the screw.

FIG. 9 shows an enlarged detail of the assembly of FIG. 8.

### DETAILED DESCRIPTION OF THE PREFERRED EMBODIMENT

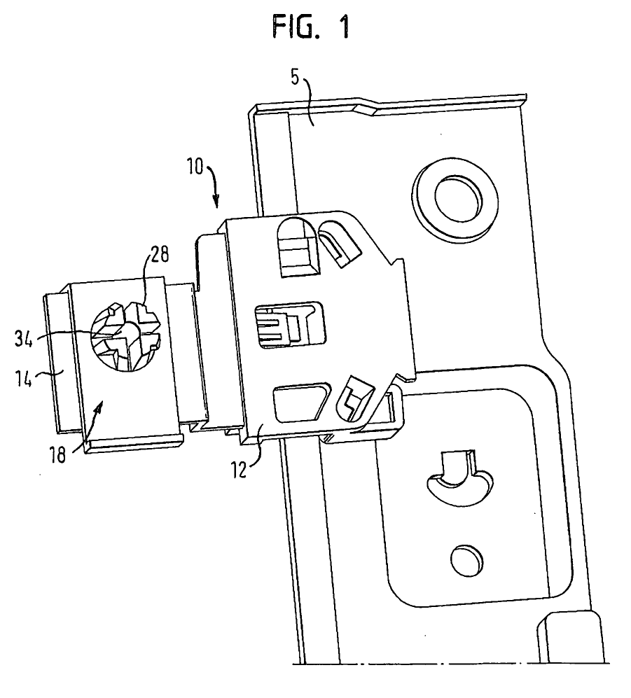

As shown in FIG. 1, a cursor 10 is mounted on guide 5 so that the cursor 10 is displaceable along the guide 5. Any mechanism can be used to displace the cursor 10 along the guide 5. This mechanism is not shown as the mechanism is not necessary for a proper understanding of the invention.

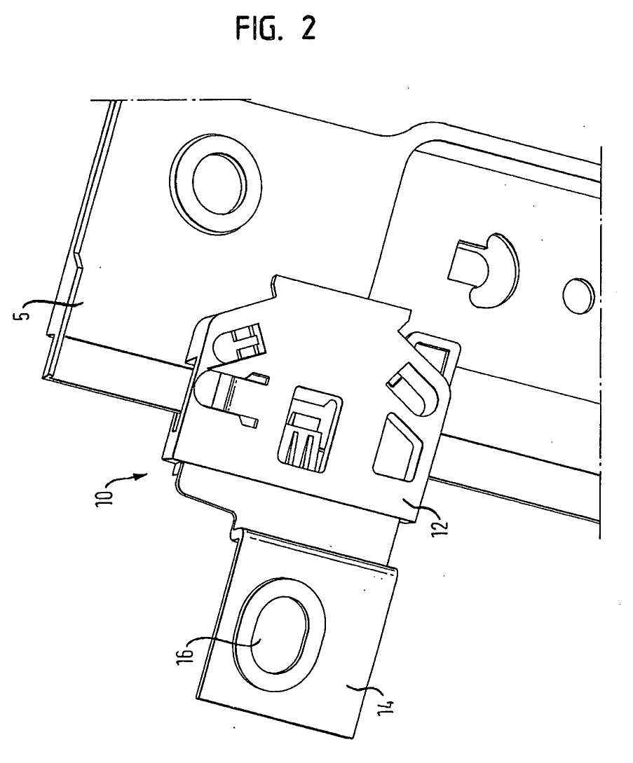

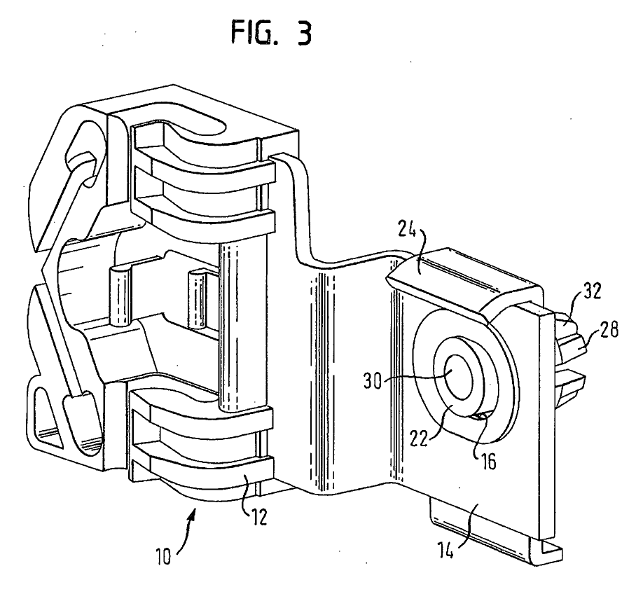

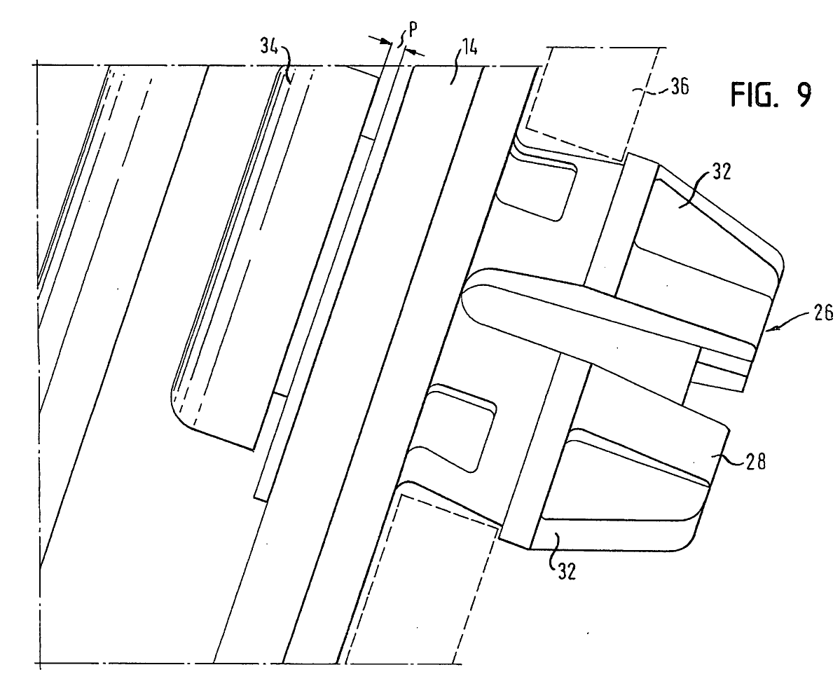

The cursor 10 (see in particular FIGS. 2 and 3) comprises a body 12 that is associated with guide 5, and a fastening tab 14 that is associated with a window pane 36 (FIG. 9). Body 12 and fastening tab 14 are preferably formed in one piece with each other from a plastic material. An oblong hole 16 is provided in fastening tab 14. The oblong hole 16 has a longer axis that is arranged to be more or less parallel to a longitudinal axis of a vehicle (typically designated as an X-axis.)

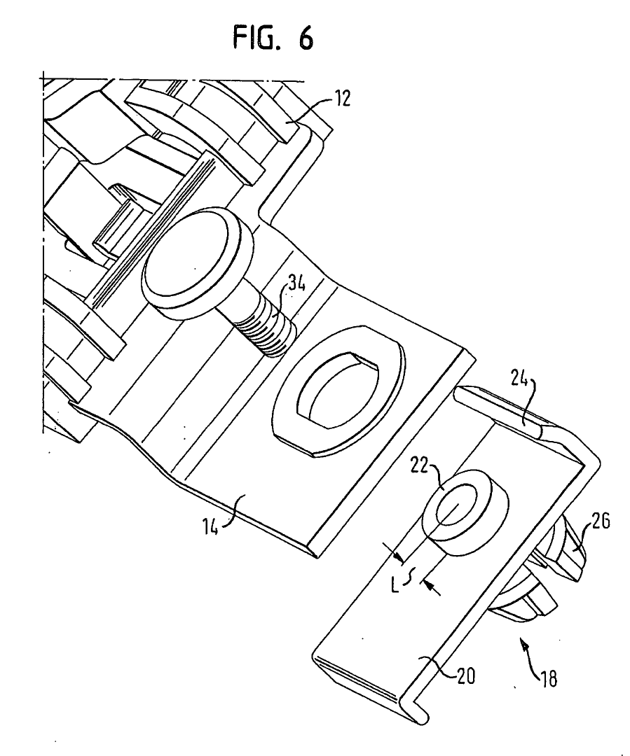

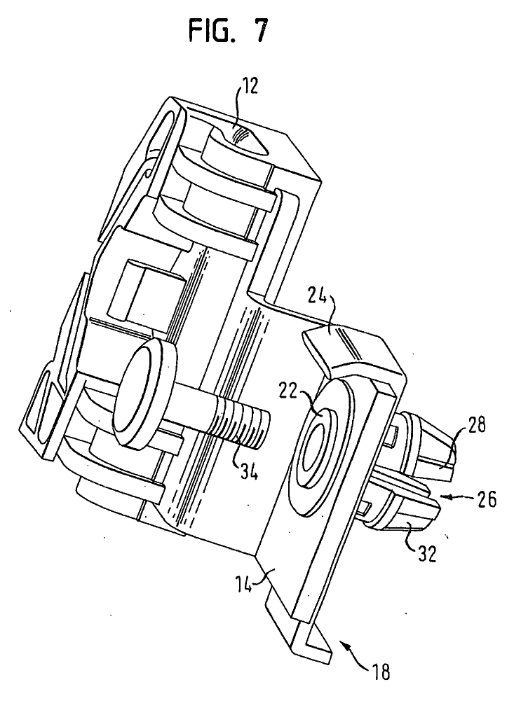

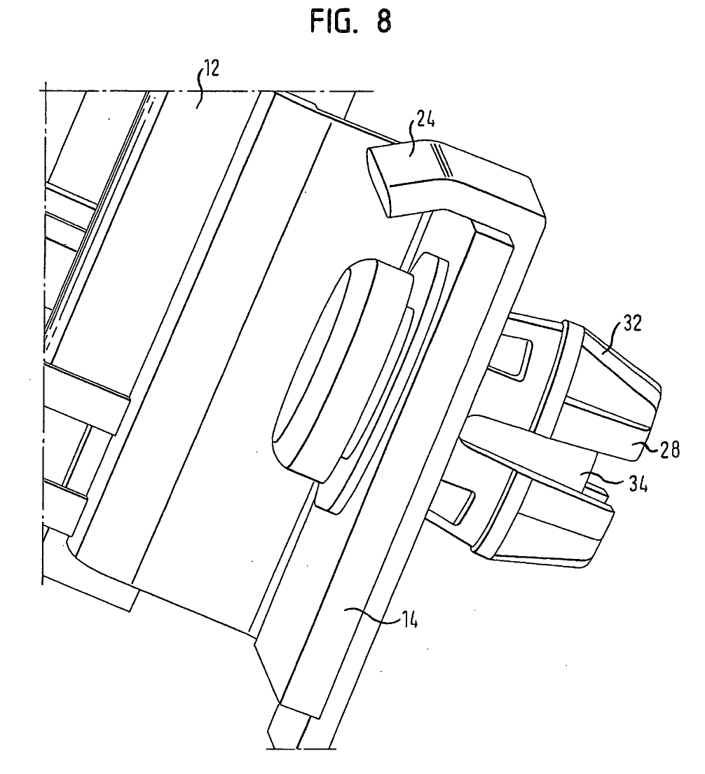

A fastening clip 18 (see FIGS. 6 and 7) is provided that comprises a body 20, a cylindrical projection 22, a holding lug 24, and a fastening configuration 26. Projection 22 has a diameter that corresponds to a width of the oblong hole 16, and a height L (see FIG. 6) that is slightly larger than a wall thickness of fastening tab 14 in a region of an edge of the oblong hole 16. Preferably, fastening clip 18 is also formed from a plastic material.

The guide 5 shown in FIG. 1 is part of a window regulator system. In a particular embodiment, the guide 5 is part of a window regulator system that is used in vehicles, and which is mounted in a vertical or almost vertical direction to a side part of a vehicle body.

Holding lug 24 extends from body 20 in a direction that is generally perpendicular to body 20. The holding lug 24 serves to provisionally hold the fastening clip 18 to the cursor 10 during the assembly process. This will be described later.

Fastening configuration 26 is formed from four (4) fastening lugs 28 (FIG. 1) that each extend over a sector of almost 90°, and are formed such that the fastening configuration 26 has a circular shape with a central opening 30 (FIG. 3). Each of the fastening lugs 28 comprises a nose 32 (FIG. 3) that is provided to engage on a surface of a window pane that is opposite to a surface contacting the body 20 of the fastening clip 18.

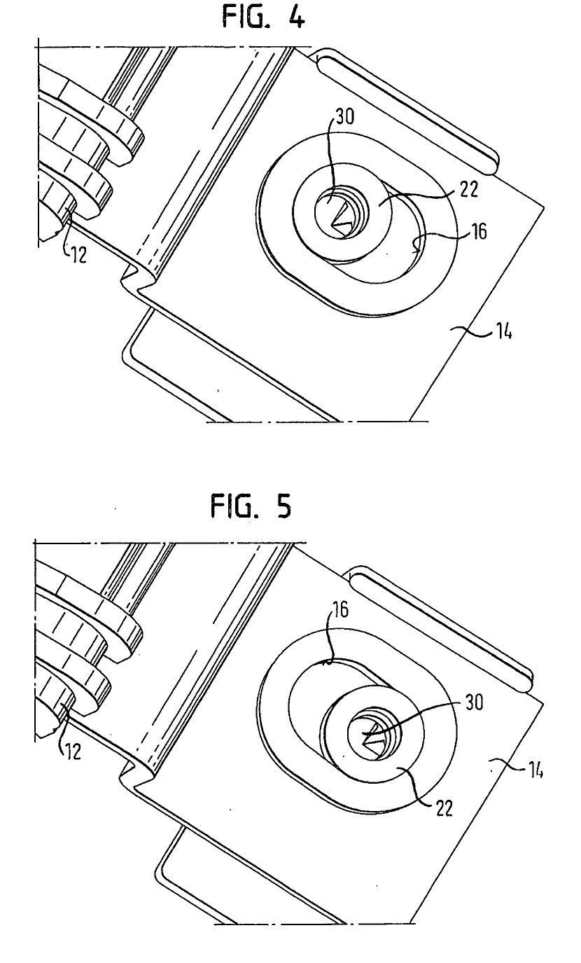

To assemble the cursor assembly, the fastening clip 18 is arranged on fastening tab 14 such that the projection 22 of fastening tab 14 extends through the oblong hole 16, as shown in FIG. 7. Holding lug 24 serves to provisionally hold the fastening clip 18 in this position. Thereafter, a window pane 36, schematically depicted in FIG. 9, is mounted so that fastening lugs 28 extend through an opening in the window pane 36. Thereafter, a screw 34 is inserted into central opening 30 so that a screw shank spreads apart the fastening lugs 28, thereby firmly connecting the window pane 36 to the fastening clip 18. Screw 34 is tightened until a screw head abuts on a free end of projection 22, which thereby acts as a stop for the screw 34. Since the height of projection 22 is larger than the wall thickness of fastening tab 14, a small clearance P (see FIG. 9) remains between the screw head of screw 34 and fastening tab 14. This clearance ensures that the fastening clip 18 can be displaced within the oblong hole 16 between two extreme positions, shown in FIGS. 4 and 5 respectively, by reliably preventing fastening tab 14 from being clamped between the screw head and the fastening clip 18. Further, screw 34 provides superior theft protection since the screw 34 extends through the fastening tab 14 of cursor 10, fastening clip 18, and the opening of the window pane 36, thereby adding significant strength to the assembly which, apart from the screw 34, is made of plastic material.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A cursor assembly for a window regulator, in particular for vehicles, comprising:
a cursor adapted to be displaced along a guide;
a fastening clip attached to the cursor to be displaceable with respect to the cursor over a predefined path; and
a fastening configuration adapted to be fastened to a window pane.

2. The cursor assembly of claim 1 wherein an oblong hole is used to attach the fastening clip to the cursor.

3. The cursor assembly of claim 2 wherein the oblong hole is provided on the cursor.

4. The cursor assembly of claim 3 wherein the fastening clip has a projection that engages into the oblong hole, the projection having a diameter that is smaller than a length of the oblong hole.

5. The cursor assembly of claim 4 wherein a height of the projection is greater than a wall thickness of the cursor in a region of the oblong hole.

6. The cursor assembly of claim 1 wherein the fastening configuration comprises at least two fastening lugs that project from the fastening clip and are adapted to engage into an opening provided in the window pane.

7. The cursor assembly of claim 6 including a screw that extends through the fastening clip and spreads apart the at least two fastening lugs.

8. The cursor assembly of claim 7 wherein a free end of a projection of the fastening clip serves as a stop for a screw head of the screw.

9. The cursor assembly of claim 7 wherein the fastening clip comprises a holding lug that serves to hold the fastening clip on the cursor during assembly before insertion of the screw.

10. The cursor assembly of claim 1 wherein the cursor comprises a body associated with the guide and a fastening tab formed as one piece with the body and wherein the fastening tab includes an oblong hole that is used to attach the fastening clip to the cursor.
